(19) United States
(12) Patent Application Publication
(10) Pub. No.: US 2002/0109579 A1
(43) Pub. Date: Aug. 15, 2002

(54) Face recognition and information system

(76) Inventors: Stephen B. Pollard, Dursley (GB); Glenn Peter Hall, Stroud (GB); Stephen Philip Cheatle, Bristol (GB); Andrew Arthur Hunter, Bristol (GB)

Correspondence Address: HEWLETT-PACKARD COMPANY, Intellectual Property Administration, P.O. Box 272400, Fort Collins, CO, 80527-2400, US

(21) Appl. No.: 10/013,024

(22) Filed: Dec. 7, 2001

(30) Foreign Application Priority Data
Feb. 10, 2001 (GB) 0103353.9

(51) Int. Cl. H04Q 1/00

(52) U.S. Cl. 340/5.53

(57) ABSTRACT

A face recognition and information system comprises a headset bearing a camera 10 which is used to capture images in the direction of a user's gaze. The images are processed and any faces in those images are identified from a database which may be held in control means 16. Once the face has been identified information relating to that person will be outputted through a visual display 14 or an earpiece 18 to unobtrusively provide information relating to the person identified.

This invention relates to a face recognition and information system and to a method for recognising a face and providing information about the person recognised.

Personal information, including names, about the people who we meet in a business or social setting is seldom to hand. It is either distracting or considered rude to use a device, such as a computer, to actively retrieve information about a person. Consequently, the present method of consulting notes or a computer for information concerning a person or having to ask a person for the information has disadvantages because of the embarrassment caused and a person's desire to appear well informed.

It is an object of the present invention to address the above mentioned disadvantages.

According to a first aspect of the present invention a face recognition and information system comprises image capture means, image processing means, information retrieval means and information output means, wherein the image capture means is operable to capture an image of a person's face, the image processing means is operable to process the captured image to identify the person's face, the information retrieval means is operable to retrieve information relating to the identified person; and the information output means is operable to output information to a user of the system, and wherein the system is adapted to be worn by a user.

The system is preferably arranged for personal use by a user, preferably to provide real-time or substantially real-time recognition of individuals and supply of information related thereto.

The system may include information storage means. Alternatively the information retrieval means may be operable to retrieve information from a separate information storage means remote from the system.

The image capture means may be a camera. The image processing means and/or the information retrieval means may be computing means.

The information output means may be a visual display or may be an audio output device, in the latter case the information retrieval means may include speech synthesis means. The audio output device may be an ear piece.

Preferably, the image capture means is operable to be secured to a user, preferably to a user's head in order to face substantially forwards in the direction of a user's gaze, preferably to the side of a user's head.

Preferably, the information output means is secured to the image capture means to form a headset. The information output means may extend forwards of the image capture means on a boom, to be in the view of a user.

The image processing means and the information retrieval means may form at least a part of a control means of the system, which control means may be arranged to be spaced from the remainder of the system. The control means may adapted adapted to be secured to or retained in a user's clothing. The control means may communicate with the image capture means and information output means via a wire link or via a wireless link.

The control means may include an information storage means.

The system may be operable to receive commands via the control means, which commands may specify a source for information to be retrieved. The commands may be receivable via a keypad of the control means.

The system may be operable to pass an image captured by the image capture means to the image processing means. The image processing means may be operable to then process the image to determine whether the image contains a face, and if so, to identify features of the face and compare those features against features stored in an information storage means. If the captured face is matched to a face stored in the storage means, the information retrieval means may retrieve information concerning the person whose face has been identified and may pass that information to the information output means, either in visual format or audio format.

The information retrieved by the information retrieval means may be the name of the person identified, their job title, personal details, bank details, or family information.

The invention extends to a kit of parts comprising image capture means; image processing means; information retrieval means and information outputting means adapted to be assembled into the face recognition and information system of the first aspect.

According to a second aspect of the present invention a method of recognising a face of a person and providing information about that person comprises:

capturing an image of a person's face with image capture means;

supplying the image to image processing means;

processing the captured image to identify the person's face with the image processing means;

supplying the identity of the person to information retrieval means;

retrieving information relating to the identified person with information retrieval means; and

outputting the information relating to the identified person to a user with information output means;

wherein the image capture means, image processing means, information retrieval means and information outputting means form a face recognition and information system which in use is worn by a user.

According to a third aspect of the invention a face recognition and information system comprises image capture means, image processing means, information retrieval means and information output means; wherein the image capture means and information output means are in the form of a headset adapted to be worn by a user.

The image processing means and the information retrieval means may be in the form of a control unit separate from the headset. The control unit preferably includes communication means for communicating with corresponding communication means of the headset.

All of the features described herein may be combined with either of the aspects described above, in any combination.

Specific embodiments of the present invention will now be described, by way of example, and with reference to the accompanying drawings, in which:

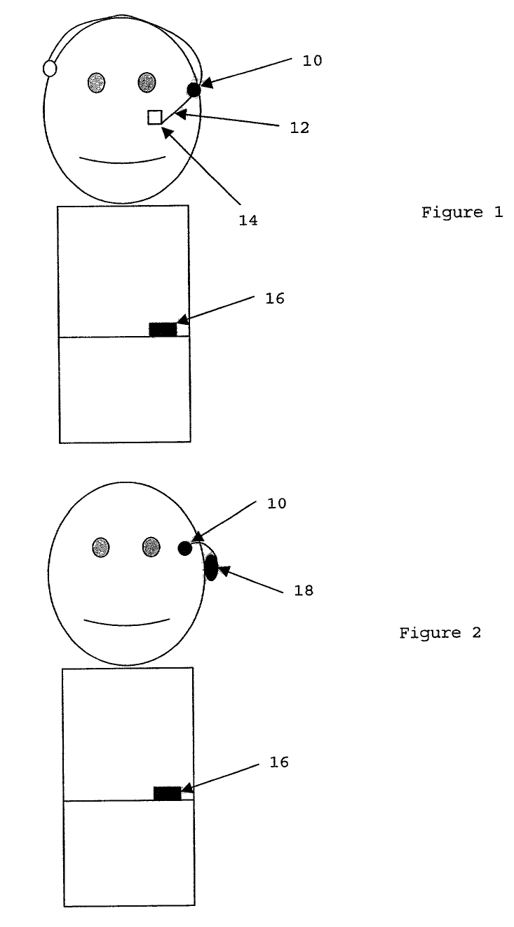

FIG. 1 shows a headset worn by a user consisting of a micro-camera and micro-display which communicate with a body mounted control device; and

FIG. 2 shows a schematic diagram of a headset comprising a micro-camera and audio feedback device connected to a large control worn by a user.

A recognition system 8 shown in FIG. 1 comprises a micro-camera 10 attached by a boom 12 to a micro-display 14.

A control portion 16 may optionally be located within the casing of the micro-camera 10 and boom 12, or alternatively may be located as shown in FIG. 1 on the user's body. The control portion 16, when remote from the camera 10, boom 12 and display 14 may be physically connected by wire or may alternatively communicate via a wireless link, such as the “Blue tooth” standard link, which is a high frequency broadcast standard. In use, the micro-camera 10 is secured to a user's head and is pointed in the direction of their gaze.

An image is captured by the micro-camera 10 and is processed to determine whether a face is present in the image. If so, the image is further processed to determine whether the face recognised is one of a number of faces included in a database stored in the control portion 16. A further alternative would be for the control portion 16 to communicate with a database remote from the user, which database may have a large stock of faces which could potentially be recognised.

The database may be particular to a given building which a user of the recognition system has entered. For example, a user entering a particular office of a known organisation may enter details into the control portion 16 via an interface of that particular office or connect to a company's website to have ready for access a database of faces which could potentially be recognised in that office building. Alternatively, a bank manager or doctor may connect via the control portion 16 to a database of his customers or patients respectively.

Recognition of a face captured on an image with the micro-camera 10 can be performed using existing techniques. These techniques are described in the following references:

Beyond Eigenfaces: Probabilistic Matching for Face Recognition Moghaddam B., Wahid W. & Pentland A. International Conference on Automatic Face & Gesture Recognition, Nara, Japan, April 1998.

Probabilistic Visual Learning for Object Representation Moghaddam B. & Pentland A. Pattern Analysis and Machine Intelligence, PAMI-19 (7), pp. 696-710, July 1997

A Bayesian Similarity Measure for Direct Image Matching Moghaddam B., Nastar C. & Pentland A. International Conference on Pattern Recognition, Vienna, Austria, August 1996.

Bayesian Face Recognition Using Deformable Intensity Surfaces Moghaddam B., Nastar C. & Pentland A.IEEE Conf. on Computer Vision & Pattern Recognition, San Francisco, Calif., June 1996.

Active Face Tracking and Pose Estimation in an Interactive Room Darrell T., Moghaddam B. & Pentland A. IEEE Conf. on Computer Vision & Pattern Recognition, San Francisco, Calif., June 1996.

Generalized Image Matching: Statistical Learning of Physically-Based Deformations Nastar C., Moghaddam B. & Pentland A. Fourth European Conference on Computer Vision, Cambridge, UK, April 1996.

Probabilistic Visual Learning for Object Detection Moghaddam B. & Pentland A. International Conference on Computer Vision, Cambridge, Mass., June 1995.

A Subspace Method for Maximum Likelihood Target Detection Moghaddam B. & Pentland A. International Conference on Image Processing, Washington D.C., October 1995.

An Automatic System for Model-Based Coding of Faces Moghaddam B. & Pentland A.IEEE Data Compression Conference, Snowbird, Utah, March 1995.

View-Based and Modular Eigenspaces for Face Recognition Pentland A., Moghaddam B. & Starner T. IEEE Conf. on Computer Vision & Pattern Recognition, Seattle, Wash., July 1994.

Once the face captured by the micro-camera 10 has been determined from the database of faces held it is a straight-forward operation to locate further information relating to the individual whose face has been recognised by cross-referencing on the database. The information may be the person's name, their position in a particular organisation, any outstanding issues between the user of the device and the person recognised, a name of a spouse or children of the person recognised, or their birthday. Alternatively, account details may be brought up for use by a bank manager using the device, or alternatively patient records for a doctor using the device.

This information will be stored by the control portion 16 or accessible thereby and is communicated to the micro-display 14.

The information is presented in text format on the micro-display 14 simply by taking information from the database concerned.

The micro-display 14 may measure only a few millimetres across, but by use of optical elements the image on the display can be made to appear further away from the display than is actually the case. This increases the apparent size of the information displayed in the micro-display 12, for easy use. Also, the small size of the micro-display 14 allows a user to look around the device.

The type of micro-display 14 which could be used is already readily available.

Companies manufacturing examples of microdisplays include:

Colorado Microdisplay Inc. (www.comicro.com) 2477 55th Street, Boulder Colo., 80301 USA.

Displaytech, Inc. (www.displaytech.com) 2602 Clover Basin Drive, Longmont, Colo. 80503-7603 USA.

Specific examples of the use of microdisplays for headmounted computer interfaces can be found at:

Displaywear Inc. (www.displaywear.com) 831 A Bransten Road, San Carlos, Calif. 94070 USA.

Tekgear Inc. (www.tekgear.ca ) 1-90 Market Avenue Winnipeg, Manitoba R3B 0P3 CANADA.

An alternative to the example described in relation to FIG. 1 is shown in FIG. 2. Instead of a micro-display 14, the device includes an audio feedback device 18 in the form of an earpiece. With this device the micro-camera 10 captures images of faces observed by the wearer and the image processing is conducted as described above to obtain information concerning the identified person. However, once the information concerning the individual recognised has been obtained, instead of being displayed on a micro-display 14, the information is converted into audio speech information by means of speech synthesis. Thus, the audio feedback device 18 when placed in a user's ear and used in conjunction with the micro-camera 10 and processing equipment mentioned above can provide all of the information described above in relation to the first embodiment to a user of the device.

Examples of speech synthesisers which can provide speech from other data are already known. Examples include: Bell Labs Text to Speech Synthesis form Lucent Technologies (see www.belllabs.com/project/tts/voices.html); and

Festival Speech Synthesis System from the University of Edinburgh. (see www.cstr.ed.ac.uk/projects/festival).

The two embodiments described above provide a solution to the problem of a person not recognising an individual approaching or speaking to them and also not knowing particular information about that person.

The advantageous provision of discrete image capture, image processing and related information output has significant advantages over existing uses of handheld computers from which information must be manually retrieved.

The invention is not restricted to the details of the foregoing embodiments.

1. A face recognition and information system comprises image capture means, image processing means, information retrieval means and information output means, wherein the image capture means is operable to capture an image of a person's face, the image processing means is operable to process the captured image to identify the person's face, the information retrieval means is operable to retrieve information relating to the identified person; and the information output means is operable to output information to a user of the system, and wherein the system is adapted to be worn by a user.

2. A face recognition and information system as claimed in claim 1, which is arranged for personal use by a user, to provide real-time or substantially real-time recognition of individuals and supply of information related thereto.

3. A face recognition and information system as claimed in either claim 1 or claim 2, which includes information storage means.

4. A face recognition and information system as claimed in either claim 1 or claim 2, in which the information retrieval means is operable to retrieve information from a separate information storage means remote from the system.

5. A face recognition and information system as claimed in any preceding claim, in which the information output means is a visual display.

6. A face recognition and information system as claimed in any one of claims 1 to 4, in which the information output means is an audio output device.

7. A face recognition and information system as claimed in any preceding claim, in which the image capture means is operable to be secured to a user's head in order to face substantially forwards in the direction of a user's gaze.

8. A face recognition and information system as claimed in any preceding claim, in which the image processing means and the information retrieval means form at least part of a control means of the system, which control means is arranged to be spaced from the remainder of the system.

9. A face recognition and information system as claimed in claim 8, in which the control means includes an information storage means.

10. A face recognition and information system as claimed in either claim 8 or claim 9, in which the system is operable to receive commands via the control means.

11. A kit of parts comprises image capture means, image processing means, information retrieval means and information outputting means adapted to be assembled into the face recognition and information system of claims 1 to 10.

12. A method of recognising a face of a person and providing information about that person comprises:
capturing an image of a person's face with image capture means;
supplying the image to image processing means;
processing the captured image to identify the person's face with the image processing means;
supplying the identity of the person to information retrieval means;
retrieving information relating to the identified person with information retrieval means; and
outputting the information relating to the identified person to a user with information output means;
wherein the image capture means, image processing means, information retrieval means and information outputting means form a face recognition and information system which in use is worn by a user.

13. A face recognition and information system comprises image capture means, image processing means, information retrieval means and information output means; wherein the image capture means and information output means are in the form of a headset adapted to be worn by a user.

14. A face recognition and information system substantially as described herein with reference to the accompanying drawings.

15. A method of recognising a face of a person and providing information about that person substantially as described herein with reference to the accompanying drawings.
